(19) United States
(12) Patent Application Publication
(10) Pub. No.: US 2018/0342079 A1
(43) Pub. Date: Nov. 29, 2018

(54) IMAGE PROCESSING APPARATUS, IMAGE PROCESSING METHOD, AND COMPUTER READABLE RECORDING MEDIUM

(71) Applicant: OLYMPUS CORPORATION, Tokyo (JP)

(72) Inventor: Yoichi YAGUCHI, Tokyo (JP)

(73) Assignee: OLYMPUS CORPORATION, Tokyo (JP)

(21) Appl. No.: 16/035,745

(22) Filed: Jul. 16, 2018

Related U.S. Application Data
(63) Continuation of application No. PCT/JP2016/051455, filed on Jan. 19, 2016.

(51) Int. Cl. G06T 7/73; G06T 7/00

(52) U.S. Cl. CPC G06T 7/74; G06T 2207/30004; G06T 2207/10068; G06T 7/0014

(57) ABSTRACT

An endoscope image processing apparatus comprising a processor comprising hardware. The processor executes: acquiring subject images; generating space information of a superimposed object to be superimposed on the subject image, and to be arranged so as to correspond to a location of interest detected from a detection target subject image different from a superimposition target subject image; deciding the superimposition target subject image to be displayed together with the superimposed object, according to a time at which the space information has generated; generating entire image correspondence information that estimates correspondence between the detection target subject image and the superimposition target subject image, using the entire detection target subject image; correcting space information of the superimposed object based on the information that estimates correspondence between the detection target subject image and the superimposition target subject image; and superimposing the corrected superimposed object on the decided superimposition target subject image.

### CROSS-REFERENCE TO RELATED APPLICATION

This application is a continuation of International Application No. PCT/JP2016/051455, filed on Jan. 19, 2016, the entire contents of which are incorporated herein by reference.

### BACKGROUND

The present disclosure relates to an image processing apparatus, an image processing method, and a computer readable recording medium.

In the related art, endoscopic devices are widely used for various inspections in the medical field and the industrial field. Among these endoscopic devices, a medical endoscopic device may acquire an image of the inside of a subject (subject image) without cutting open the subject, by inserting, into the subject such as a patient, a flexible insertion portion having an elongated shape and having an image sensor including a plurality of pixels that is provided at a distal end. Thus, such a medical endoscopic device has a less burden on the subject, and has become widespread.

In the observation of a subject image using such an endoscopic device, as a result of image analysis, information (hereinafter, referred to as an object) that instructs a location of interest such as a lesion detection result is superimposed on the subject image, and displayed on an observation screen. As a technique of superimposing an object on a subject image, there is known a technique of superimposing an object on a captured image acquired at a time point at which processing of detecting a moving object (location of interest) in the captured image, as an object, and cutting out the object is completed (e.g., refer to JP 2014-220618 A).

### SUMMARY

An endoscope image processing apparatus according to one aspect of the present disclosure includes: a processor comprising hardware, the processor being configured to execute: acquiring a plurality of subject images; generating space information of a superimposed object that is a superimposed object to be superimposed on the subject image, and is to be arranged so as to correspond to a location of interest detected from a detection target subject image that is different from a superimposition target subject image; deciding the superimposition target subject image to be displayed on a display unit together with the superimposed object, according to a time at which the space information has generated; generating entire image correspondence information being information that estimates correspondence between the detection target subject image and the superimposition target subject image, using the entire detection target subject image; correcting space information of the superimposed object based on the information that estimates correspondence between the detection target subject image and the superimposition target subject image; and superimposing the corrected superimposed object on the decided superimposition target subject image.

The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a block diagram illustrating a functional configuration of an image processing system according to a first embodiment;

FIG. 2 is a diagram illustrating object superimposition processing performed by an image processing apparatus according to the first embodiment;

FIG. 3 is a diagram illustrating an object superimposition image generated by the image processing apparatus according to the first embodiment;

FIG. 4 is a diagram illustrating an object superimposition image generated by conventional processing;

FIG. 5 is a flowchart illustrating object superimposition processing performed by the image processing apparatus according to the first embodiment;

FIG. 6 is a block diagram illustrating a functional configuration of an image processing system according to a modified example of the first embodiment;

FIG. 7 is a block diagram illustrating a functional configuration of an image processing system according to a second embodiment;

FIG. 8 is a flowchart illustrating object superimposition processing performed by an image processing apparatus according to the second embodiment;

FIG. 9 is a block diagram illustrating a functional configuration of an image processing system according to a third embodiment; and

FIG. 10 is a flowchart illustrating object superimposition processing performed by an image processing apparatus according to the third embodiment.

### DETAILED DESCRIPTION

Embodiments will be described in detail below with reference to the drawings. In addition, the present disclosure is not limited to the following embodiments. In addition, the drawings to be referred to in the following description only schematically illustrate shapes, sizes, and positional relationships to such a degree that the description may be understood. In other words, the present disclosure is not limited to the shapes, sizes, and positional relationships that are exemplified in the drawings. In addition, the description will be given with the same configurations being assigned the same signs.

### First Embodiment

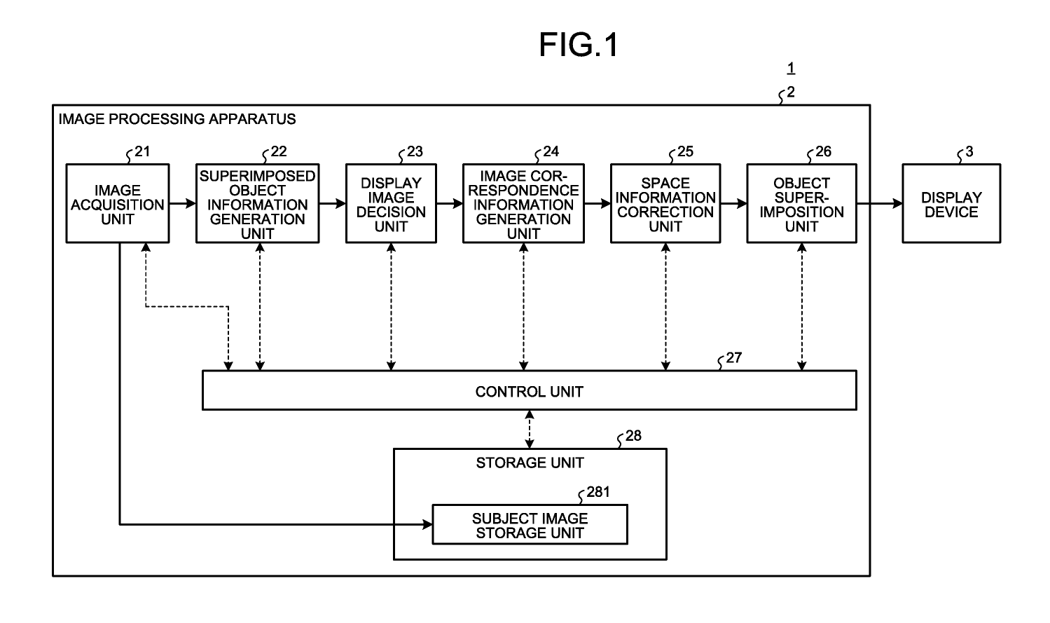

FIG. 1 is a block diagram illustrating a functional configuration of an image processing system 1 according to a first embodiment. The image processing system 1 illustrated in FIG. 1 includes an image processing apparatus 2 and a display device 3. The image processing apparatus 2 performs processing on an acquired image, thereby generating a display image signal to be displayed by the display device 3. The display device 3 receives, via a video cable, the image signal generated by the image processing apparatus 2, and displays an image corresponding to the image signal. The display device 3 is formed by using a liquid crystal or organic Electro Luminescence (EL). In addition, in FIG. 1, solid-line arrows indicate transmission of signals related to images, and broken-line arrows indicate transmission of signals related to control.

The image processing apparatus 2 includes an image acquisition unit 21, a superimposed object information generation unit 22, a display image decision unit 23, an image correspondence information generation unit 24, a space information correction unit 25, an object superimposition unit 26, a control unit 27, and a storage unit 28. The storage unit 28 includes a subject image storage unit 281 that stores a subject image acquired by the image acquisition unit 21.

The image acquisition unit 21 sequentially receives image signals including subject images, from the outside, in temporal sequence, or acquires images stored in the storage unit 28, in temporal sequence. The image acquisition unit 21 performs, as necessary, signal processing such as denoising, A/D conversion, and synchronization processing (e.g., performed when an imaging signal of each color component is obtained using a color filter or the like), thereby generating an image signal including a three-CCD subject image to which color components of RGB are granted, for example. The image acquisition unit 21 inputs an acquired image signal or an image signal having been subjected to the signal processing, to the superimposed object information generation unit 22 and the storage unit 28. In addition to the aforementioned synchronization processing, the image acquisition unit 21 may perform OB clamp processing, gain adjustment processing, and the like. Examples of images include a subject image including a subject that has been acquired (captured) in temporal sequence, such as an image including a subject such as a human, and a body cavity image of the inside of a subject that is acquired by an endoscope (including a capsule endoscope).

Using a subject image that is based on an image signal input from the image acquisition unit 21, the superimposed object information generation unit 22 detects a notable location (hereinafter, also referred to as a location of interest) in the subject image, such as a lesion portion in the case of an in-vivo image of the inside of the subject, for example, and generates space information of a superimposed object that is an object indicating the detected location of interest, and is to be arranged with being superimposed on the location of interest of the subject image. A detection target subject image from which a location of interest is to be detected is a subject image being different from a superimposition target subject image on which a superimposed object is to be superimposed, and is a detection target subject image being a subject image acquired prior to the superimposition target subject image in temporal sequence. The superimposed object here refers to a rectangular frame encompassing a lesion portion, for example, when the subject image is a body cavity image of the inside of the subject. In addition, the space information refers to coordinate information of a space in which the frame of the superimposed object is positioned, when the subject image is viewed in a two-dimensional plane, and information regarding coordinates of four corners of the rectangular frame, for example. In addition, aside from the aforementioned coordinate information, the space information may be any of information indicating a region mask having a transmissive window through which the location of interest is transmitted, and information indicating an outline encompassing the location of interest, or may be information obtained by combining the coordinate information, the region mask, and the outline.

The superimposed object information generation unit 22 may generate space information of a superimposed object using a technology described in “Object Detection with Discriminatively Trained Part-Based Models” Pedro F. Felzenszwalb, Ross B. Girshick, David McAllester and Deva Ramanan, PAMI2010, for example.

The display image decision unit 23 decides a subject image to be displayed on the display device 3, according to a time at which the superimposed object information generation unit 22 has generated the space information.

The image correspondence information generation unit 24 generates image correspondence information being information that estimates correspondence between the subject image (detection target subject image) for which the superimposed object information generation unit 22 has generated the space information of the superimposed object, and the subject image (superimposition target subject image) decided by the display image decision unit 23. Specifically, the image correspondence information generation unit 24 generates image correspondence information between the detection target subject image and the superimposition target subject image that is represented by at least one coordinate transform of nonrigid transform, nomography transform, affine transform, linear transform, scale transform, rotation transform, and parallel displacement. For example, the technology described in JP 2007-257287 A is used for the generation of image correspondence information.

The space information correction unit 25 corrects the space information of the superimposed object that has been generated by the superimposed object information generation unit 22, according to the image correspondence information generated by the image correspondence information generation unit 24. In this first embodiment, the space information correction unit 25 corrects the space information based on the image correspondence information (transform parameter) generated by the image correspondence information generation unit 24, for the space information (coordinate information) of the superimposed object that has been generated by the superimposed object information generation unit 22.

The object superimposition unit 26 performs superimposition on the subject image decided by the display image decision unit 23, according to the space information of the superimposed object that has been corrected by the space information correction unit 25.

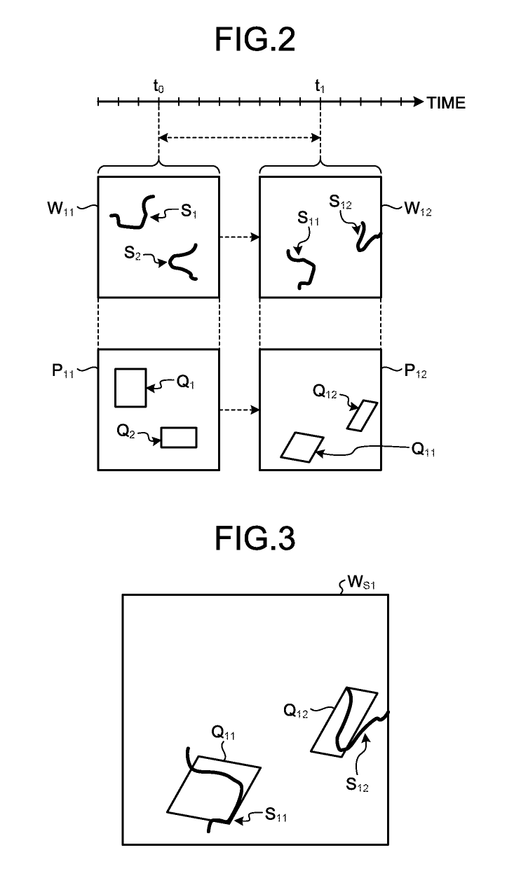

FIGS. 2 and 3 are diagrams illustrating object superimposition processing performed by the image processing apparatus 2 according to the first embodiment. The superimposed object information generation unit 22 detects a superimposed object to be superimposed on a subject image input from the image acquisition unit 21, from a detection target subject image W₁₁ at a time t₀, and generates space information of the superimposed object. As illustrated in FIG. 2, for example, the superimposed object information generation unit 22 generates, as space information, coordinates of four corners of each of superimposed objects Q₁ and Q₂ in an object space P₁₁ set according to the outer rim of the subject image W₁₁. The superimposed objects Q₁ and Q₂ are rectangular frames encompassing lesion portions S₁ and S₂. In addition, aside from rectangular frames, they may be ellipsoidal or circular frames, may have shapes corresponding to locations of interest, or may be filled objects.

When a time at which the superimposed object information generation unit 22 has completed the generation of space information is denoted by t₁, the display image decision unit 23 decides a subject image W₁₂ (refer to FIG. 2) set according to the time t₁, as a subject image (superimposition target subject image) to be displayed on the display device 3. In the subject image W₁₂, lesion portions S₁₁ and S₁₂ obtained by changing the positions and orientations of the lesion portions S₁ and S₂ in the subject image W₁₁ are displayed. In addition, in a time from the time t₀ to the time t₁, a plurality of subject images are input in addition to the subject images W₁₁ and W₁₂. In other words, a time in which subject images corresponding to several frames are input is required for the superimposed object information generation unit 22 completing the generation of space information since the generation is started. FIG. 2 only illustrates the subject image W₁₁ and W₁₂ for the sake of description.

The image correspondence information generation unit 24 generates image correspondence information including a transform parameter representing correspondence between the subject image W₁₁ for which the superimposed object information generation unit 22 has generated the superimposed objects Q₁ and Q₂, and the subject image W₁₂ decided by the display image decision unit 23.

The image correspondence information generation unit 24 generates, for the subject image W₁₁ and the subject image W₁₂, image correspondence information that is represented by at least one coordinate transform of nonrigid transform, nomography transform, affine transform, linear transform, scale transform, rotation transform, and parallel displacement.

The space information correction unit 25 generates space information obtained by transforming each coordinate of the space information of the superimposed object that has been generated by the superimposed object information generation unit 22 based on the transform parameter of the image correspondence information generated by the image correspondence information generation unit 24, as space information of the corrected superimposed object (e.g., the superimposed objects Q₁₁ and Q₁₂). For example, the space information correction unit 25 generates space information of the corrected superimposed object by transforming, using matrix operation, each coordinate of space information of the superimposed object that has been generated by the superimposed object information generation unit 22.

For example, the object superimposition unit 26 generates a subject image W_{S1} in which the lesion portions S₁₁ and S₁₂ are partially encompassed by the superimposed objects Q₁₁ and Q₁₂, as illustrated in FIG. 3, by superimposing the superimposed objects Q₁₁ and Q₁₂ (refer to FIG. 2) corrected by the space information correction unit 25, on the subject image W₁₂ (refer to FIG. 2) decided by the display image decision unit 23.

Through the aforementioned processing, even in the case of extracting the superimposed objects Q₁ and Q₂ from the subject image W₁₁, and superimposing the superimposed objects extracted from the subject image W₁₁, on the subject image W₁₂ in which the positions and orientations of the lesion portion S₁ and S₂ in the subject image W₁₁ are changed to those of the lesion portions S₁₁ and S₁₂, the superimposed objects may be arranged at appropriate positions with respect to the lesion portions S₁₁ and S₁₂.

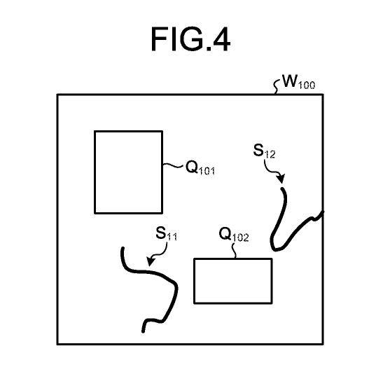

FIG. 4 is a diagram illustrating an object superimposition image generated by conventional processing. In a case in which space information of superimposed objects is not corrected as in the conventional technology, as in a subject image W₁₀₀ illustrated in FIG. 4, superimposed objects Q₁₀₀ and Q₁₀₂ are not appropriately arranged with respect to the lesion portions S₁₁ and S₁₂.

Referring back to FIG. 1, the control unit 27 is formed by using a central processing unit (CPU) and the like, and performs drive control of components constituting the image processing apparatus 2, and input output control of information for each component.

The storage unit 28 stores various programs for operating the image processing system 1 including the image processing apparatus 2, such as an image processing program, for example, and data including various parameters and the like that are necessary for the operations of the image processing system 1. The storage unit 28 is implemented by using a semiconductor memory such as a flash memory and a dynamic random access memory (DRAM).

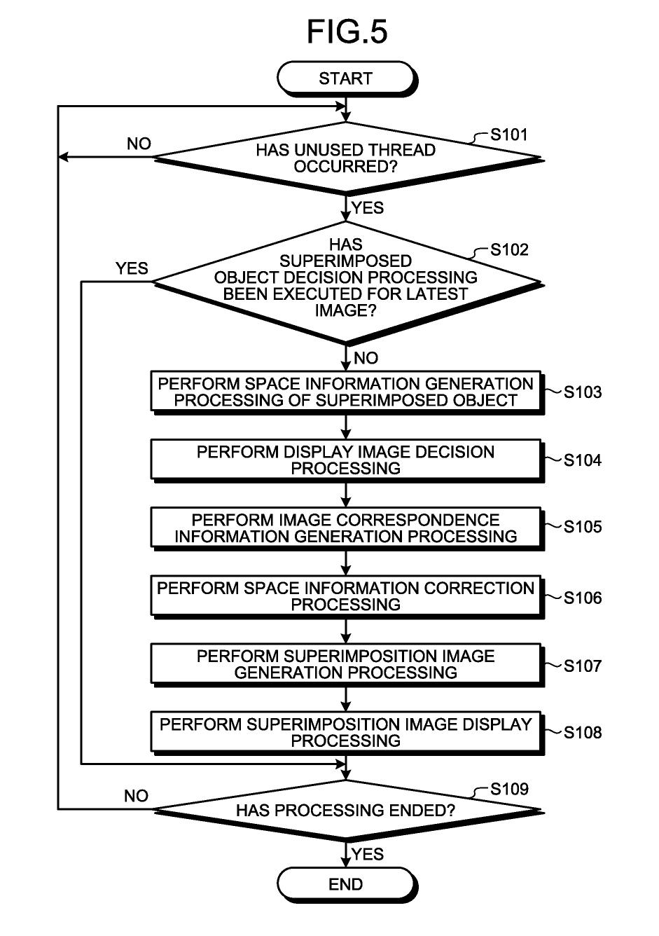

Subsequently, processing performed by each unit of the image processing apparatus 2 will be described with reference to the drawings. FIG. 5 is a flowchart illustrating processing performed by the image processing apparatus 2 according to the first embodiment. The description will be given below assuming that each unit operates under the control of the control unit 27.

First, the control unit 27 determines whether an unused thread has occurred (Step S101). The control unit 27 determines whether an unused thread has occurred, by checking a usage rate or the like of the CPU, for example. Here, if the control unit 27 determines that an unused thread has not occurred (Step S101: No), confirmation as to whether an unused thread has occurred is repeated. On the other hand, if the control unit 27 determines that an unused thread has occurred (Step S101: Yes), the processing shifts to Step S102.

In Step S102, the control unit 27 determines whether a latest image being a subject image acquired by the image acquisition unit 21 is a subject image for which a superimposed object has been decided. Here, if the control unit 27 determines that the latest image is a subject image for which a superimposed object has been decided (Step S102: Yes), the processing shifts to Step S109. In contrast to this, if the control unit 27 determines that the latest image is not a subject image for which a superimposed object has been decided (Step S102: No), the processing shifts to Step S103. In addition, a state in which a superimposed object has been decided that is said in this step includes a state in which superimposed object decision processing has been executed, or is being executed, and if the control unit 27 determines that the superimposed object decision processing has been executed, or is being executed, the processing shifts to Step S109.

In Step S103, the superimposed object information generation unit 22 generates space information of superimposed objects to be superimposed on the subject image input from the image acquisition unit 21, from a detection target subject image (e.g., the aforementioned subject image W₁₁, refer to FIG. 2). The superimposed object information generation unit 22 outputs the generated space information to the display image decision unit 23.

After that, the display image decision unit 23 decides a subject image (e.g., the aforementioned subject image W₁₂) set according to a time at which the superimposed object information generation unit 22 has completed the generation of space information, as a subject image to be displayed on the display device 3 (Step S104). The display image decision unit 23 decides a subject image being latest at the time at which the superimposed object information generation unit 22 has completed the generation of space information, or a subject image acquired immediately after the time, as a subject image to be displayed.

In Step S105 following Step S104, the image correspondence information generation unit 24 generates, for the detection target subject image used by the superimposed object information generation unit 22, and the superimposition target subject image on which superimposed objects are to be superimposed, image correspondence information that is represented by at least one coordinate transform of nonrigid transform, nomography transform, affine transform, linear transform, scale transform, rotation transform, and parallel displacement.

In Step S106 following Step S105, the space information correction unit 25 generates, as space information (corrected space information), space information obtained by transforming each coordinate of space information based on the transform parameter of the image correspondence information generated by the image correspondence information generation unit 24.

In Step S107 following Step S106, the object superimposition unit 26 generates the subject image W_{S1} (superimposition image) in which the lesion portions S₁₁ and S₁₂ are partially encompassed by the superimposed objects Q₁₁ and Q₁₂, as illustrated in FIG. 3, for example, by superimposing the superimposed objects corrected by the space information correction unit 25, on the subject image decided by the display image decision unit 23.

In Step S108 following Step S107, under the control of the control unit 27, control of displaying the subject image W_{S1} (superimposition image) generated by the object superimposition unit 26, on the display device 3 is performed. After the control unit 27 has displayed the subject image on the display device 3, the processing shifts to Step S109.

In Step S109, the control unit 27 determines whether a processing end instruction has been input. Here, if the control unit 27 determines that a processing end instruction has not been input (Step S109: No), the processing shifts to Step S101, and the aforementioned processing is repeated. On the other hand, if the control unit 27 determines that a processing end instruction has been input (Step S109: Yes), this processing ends.

In this first embodiment mentioned above, the superimposed object information generation unit 22 generates space information of superimposed objects to be superimposed on a subject image, based on a detection target subject image being a subject image that is different from a superimposition target subject image, and the display image decision unit 23 decides a subject image to be displayed on the display device 3, according to a time at which the superimposed object information generation unit 22 has completed the generation of space information. After that, the image correspondence information generation unit 24 generates image correspondence information being information that estimates correspondence between the subject image used by the superimposed object information generation unit 22 for the generation of superimposed objects, and the subject image decided by the display image decision unit 23, and the space information correction unit 25 corrects space information of superimposed objects that has been generated by the superimposed object information generation unit 22, based on the image correspondence information. After the space information of the superimposed objects has been corrected, the object superimposition unit 26 superimposes, based on the corrected superimposed objects, the superimposed objects corrected by the space information correction unit 25, on the subject image decided by the display image decision unit 23. With this configuration, even in the case of superimposing superimposed objects detected from a detection target subject image of superimposed objects, on a superimposition target subject image that is different from the detection target image, a positional shift of superimposed objects with respect to positions of locations of interest in the superimposition target subject image may be suppressed.

In addition, in the aforementioned first embodiment, the space information correction unit 25 may generate space information based on a square mean or the like of a difference between pixel values of a subject image at the time t₁ that corresponds to space information obtained by minutely changing the corrected space information, and pixel values of a subject image at the time t₀ that corresponds to space information before correction, by further correcting space information by minutely changing the corrected space information.

In addition, in the aforementioned first embodiment, image processing such as processing of enhancing edges (edge enhancement processing) may be performed on superimposed objects with corrected space information.

In addition, in this first embodiment, image correspondence information may be generated using all pixels of the subject image, or the subject image may be reduced, and image correspondence information may be generated using the reduced subject image, for suppressing a calculation amount.

Modified Example of First Embodiment

In the aforementioned first embodiment, the description has been given assuming that the superimposed object information generation unit 22 detects locations of interest in the subject image that is based on an image signal input from the image acquisition unit 21, and generates space information of superimposed objects according to the locations of interest. Nevertheless, the present disclosure is not limited to this. In this modified example, information detected by a sensor is acquired, locations of interest are detected based on the information detected by the sensor, and space information of superimposed objects is generated.

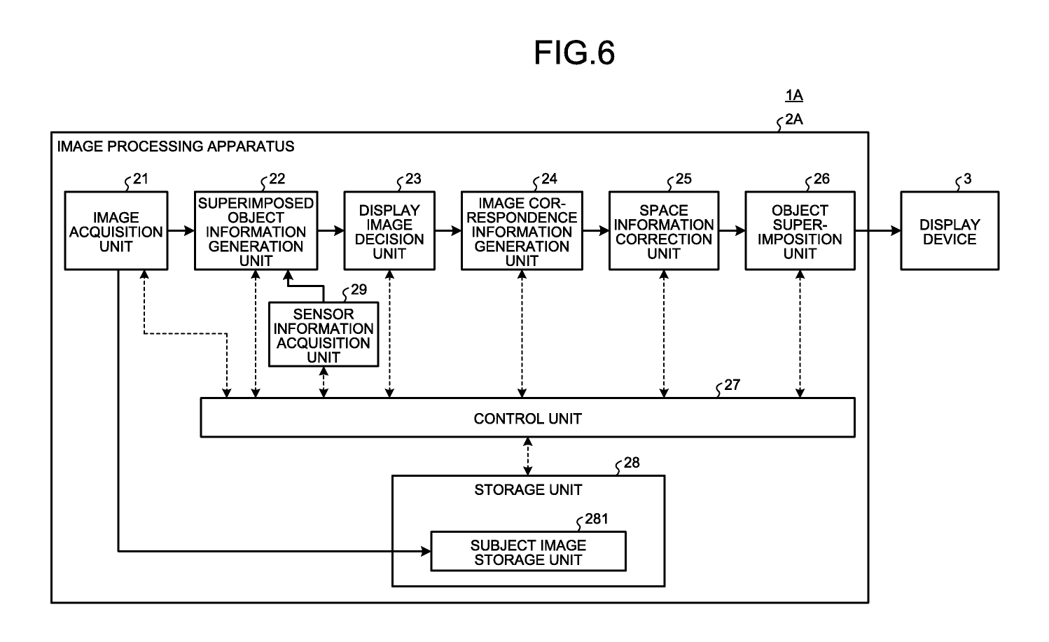

FIG. 6 is a block diagram illustrating a functional configuration of an image processing system according to a modified example of the first embodiment. An image processing system 1A according to this modified example includes an image processing apparatus 2A and the display device 3. In addition to the configuration of the aforementioned image processing apparatus 2, the image processing apparatus 2A further includes a sensor information acquisition unit 29.

The sensor information acquisition unit 29 acquires detection information from an external sensor such as, for example, an infrared sensor and a laser distance measuring device, and inputs sensor information including position information of locations of interest, to the superimposed object information generation unit 22.

If the superimposed object information generation unit 22 acquires, from the sensor information acquisition unit 29, sensor information including position information of locations of interest, the superimposed object information generation unit 22 generates, based on the position information of the sensor information, space information of superimposed objects that are object indicating locations of interest, and are to be superimposed on the locations of interest of the subject image.

After that, similarly to the first embodiment, the display image decision unit 23 decides a subject image to be displayed on the display device 3, according to a time at which the superimposed object information generation unit 22 has completed the generation of space information. In addition, the image correspondence information generation unit 24 generates image correspondence information being information that estimates correspondence between the subject image used by the superimposed object information generation unit 22 for the generation of the superimposed objects, and the subject image decided by the display image decision unit 23. After that, the space information correction unit 25 corrects space information of superimposed objects based on the image correspondence information, and the object superimposition unit 26 superimposes the superimposed objects corrected by the space information correction unit 25, on the subject image decided by the display image decision unit 23. With this configuration, even in the case of superimposing superimposed objects detected from a detection target subject image of superimposed objects, on a superimposition target subject image that is different from the detection target image, a positional shift of superimposed objects with respect to positions of locations of interest in the superimposition target subject image may be suppressed.

### Second Embodiment

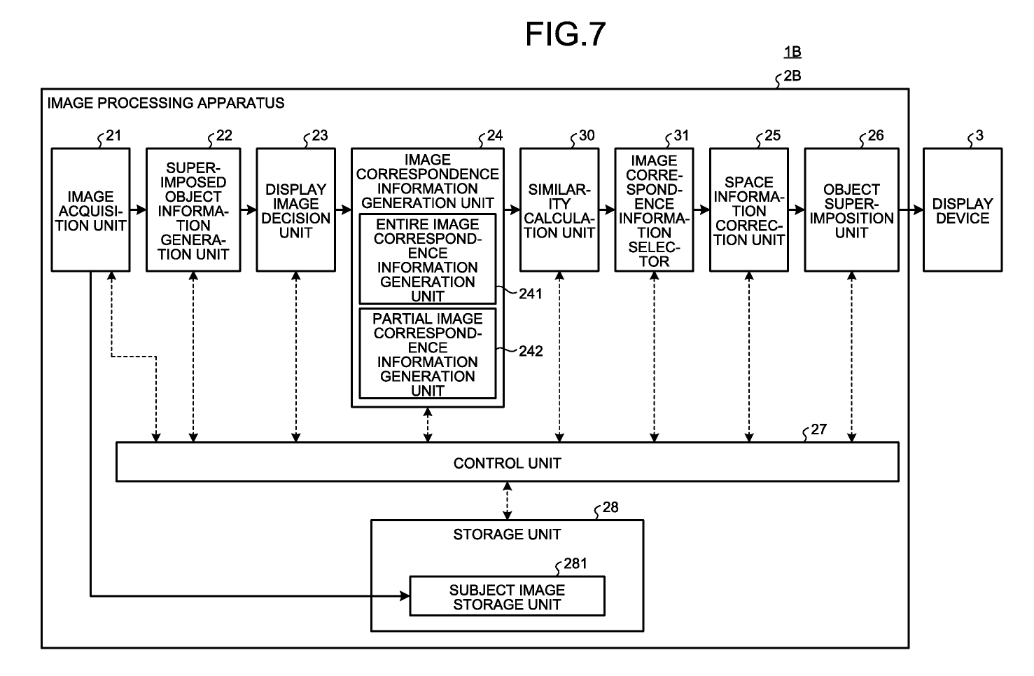

In the aforementioned first embodiment, the description has been given assuming that the image correspondence information generation unit 24 generates image correspondence information regarding correspondence between two subject images acquired at different times. Nevertheless, the image correspondence information may be image correspondence information over the entirety of the two subject images, may be image correspondence information in a partial region, or may be selectable from these. FIG. 7 is a block diagram illustrating a functional configuration of an image processing system according to a second embodiment. An image processing system 1B according to this second embodiment includes an image processing apparatus 2B and the display device 3. In addition to the configuration of the aforementioned image processing apparatus 2, the image processing apparatus 2B further includes a similarity calculation unit 30 and an image correspondence information selector 31. In addition, the image correspondence information generation unit 24 includes an entire image correspondence information generation unit 241 and a partial image correspondence information generation unit 242.

The entire image correspondence information generation unit 241 generates entire image correspondence information between a detection target subject image and a superimposition target subject image. The detection target subject image is a subject image for which the superimposed object information generation unit 22 has generated space information of superimposed objects. The superimposition target subject image is a subject image decided by the display image decision unit 23 as a target on which superimposed objects are to be superimposed. The entire image correspondence information is represented by coordinate transform generated using the entire detection target subject image. In other words, the entire image correspondence information is generated based on the entire detection target subject image.

The partial image correspondence information generation unit 242 generates partial image correspondence information between a detection target subject image and a superimposition target subject image. The partial image correspondence information is represented by coordinate transform generated using regions corresponding to arrangement regions of superimposed objects in the detection target subject image. In other words, the partial image correspondence information is generated based on the regions corresponding to arrangement regions of superimposed objects in the detection target subject image.

The similarity calculation unit 30 calculates entire image similarity (first similarity) between a first object region corresponding to a superimposition display object in the detection target subject image, and a second object region in the superimposition target subject image that is associated with the first object region using the entire image correspondence information (transform parameter), and partial image similarity (second similarity) between the first object region and a third object region in the superimposition target subject image that is associated with the first object region using the partial image correspondence information (transform parameter). The similarity calculation unit 30 may calculate, as similarity, known sum of absolute difference (SAD), may obtain, as similarity, sum of squared difference (SSD), and may obtain, as similarity, normalized cross-correction (NCC). In addition, SAD and SSD are values representing differences, and magnitude relation becomes opposite when they are used as similarity. In other words, when the difference is large, similarity becomes small, and when the difference is small, similarity becomes large.

Based on the entire image similarity and the partial image similarity that have been calculated by the similarity calculation unit 30, the image correspondence information selector 31 selects either of the entire image correspondence information and the partial image correspondence information, as image correspondence information. The image correspondence information selector 31 selects image correspondence information corresponding to higher similarity of the entire image similarity and the partial image similarity.

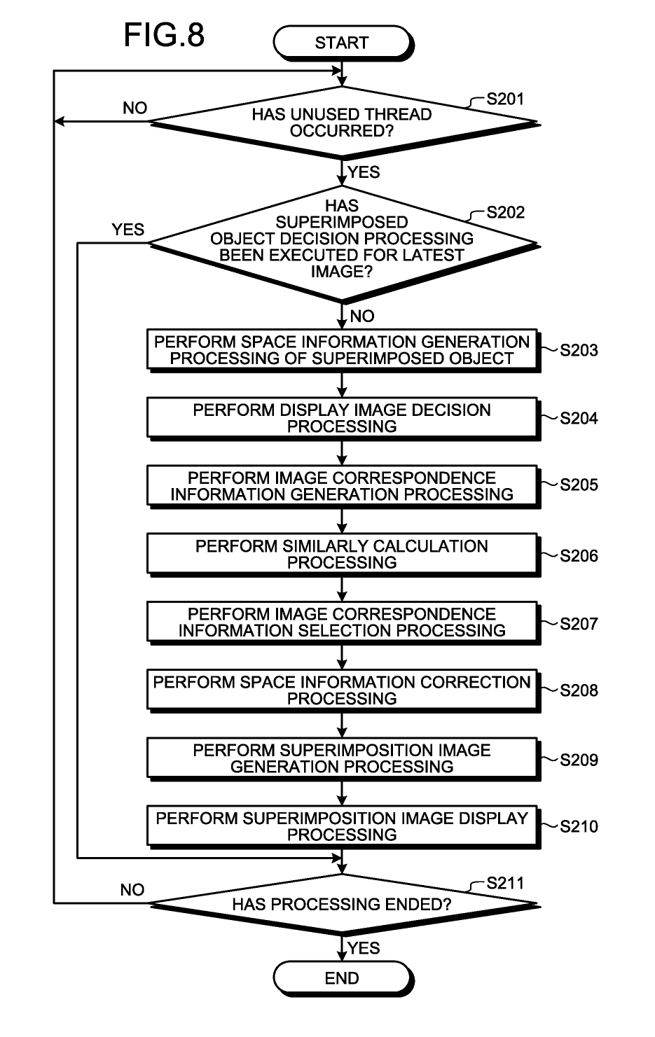

Subsequently, processing performed by each unit of the image processing apparatus 2B will be described with reference to the drawings. FIG. 8 is a flowchart illustrating processing performed by the image processing apparatus 2B according to the second embodiment. The description will be given below assuming that each unit operates under the control of the control unit 27.

First, the control unit 27 determines whether an unused thread has occurred (Step S201). The control unit 27 determines whether an unused thread has occurred, by checking a usage rate or the like of the CPU, for example. Here, if the control unit 27 determines that an unused thread has not occurred (Step S201: No), confirmation as to whether an unused thread has occurred is repeated. On the other hand, if the control unit 27 determines that an unused thread has occurred (Step S201: Yes), the processing shifts to Step S202.

In Step S202, the control unit 27 determines whether a latest image being a subject image acquired by the image acquisition unit 21 is a subject image for which a superimposed object has been decided. Here, if the control unit 27 determines that the latest image is a subject image for which a superimposed object has been decided (Step S202: Yes), the processing shifts to Step S211. In contrast to this, if the control unit 27 determines that the latest image is not a subject image for which a superimposed object has been decided (Step S202: No), the processing shifts to Step S203. In addition, a state in which a superimposed object has been decided that is said in this step includes a state in which superimposed object decision processing has been executed, or is being executed, and if the control unit 27 determines that the superimposed object decision processing has been executed, or is being executed, the processing shifts to Step S211.

In Step S203, the superimposed object information generation unit 22 generates space information of superimposed objects to be superimposed on the subject image input from the image acquisition unit 21, from a detection target subject image (e.g., the aforementioned subject image W₁₁). The superimposed object information generation unit 22 outputs the generated space information to the display image decision unit 23.

After that, the display image decision unit 23 decides a subject image set according to a time at which the superimposed object information generation unit 22 has completed the generation of space information, as a subject image to be displayed on the display device 3 (Step S204).

In Step S205 following Step S204, the image correspondence information generation unit 24 generates, for the detection target subject image used by the superimposed object information generation unit 22, and the superimposition target subject image on which superimposed objects are to be superimposed, image correspondence information that is represented by coordinate transform. In this Step S204, the entire image correspondence information generation unit 241 generates the aforementioned entire image correspondence information, and the partial image correspondence information generation unit 242 generates the aforementioned partial image correspondence information.

In Step S206 following Step S205, the similarity calculation unit 30 calculates the aforementioned entire image similarity and partial image similarity. In the following Step S207, based on the entire image similarity and the partial image similarity that have been calculated by the similarity calculation unit 30, the image correspondence information selector 31 selects either of the entire image correspondence information and the partial image correspondence information, as image correspondence information.

In Step S208 following Step S207, the space information correction unit 25 generates, as space information of corrected superimposed objects, space information obtained by transforming each coordinate of space information based on the transform parameter of the image correspondence information selected by the image correspondence information selector 31.

In Step S209 following Step S208, the object superimposition unit 26 generates a subject image W_{S1} in which the lesion portions S₁₁ and S₁₂ are partially encompassed by the superimposed objects Q₁₁ and Q₁₂, as illustrated in FIG. 3, for example, by superimposing the superimposed objects corrected by the space information correction unit 25, on the subject image decided by the display image decision unit 23.

In Step S210 following Step S209, under the control of the control unit 27, control of displaying the subject image (image on which superimposed objects are superimposed) generated by the object superimposition unit 26, on the display device 3 is performed. After the control unit 27 has displayed the subject image on the display device 3, the processing shifts to Step S211.

In Step S211, the control unit 27 determines whether a processing end instruction has been input. Here, if the control unit 27 determines that a processing end instruction has not been input (Step S211: No), the processing shifts to Step S201, and the aforementioned processing is repeated. On the other hand, if the control unit 27 determines that a processing end instruction has been input (Step S211: Yes), this processing ends.

According to this second embodiment mentioned above, the image correspondence information generation unit 24 generates a plurality of pieces of image correspondence information for different regions in the subject image, the similarity calculation unit 30 calculates similarity for each of the plurality of pieces of image correspondence information, and the image correspondence information selector 31 selects image correspondence information using the calculated similarity. With this configuration, when regions corresponding to superimposed objects moves in conjunction with the entire image, space information may be accurately corrected even if information of regions is insufficient, and when regions corresponding to superimposed objects and the entire image move differently, space information is corrected using image correspondence information of regions. Thus, space information may be corrected further accurately.

### Third Embodiment

In this third embodiment, for subject images sequentially input, a superimposed object information generation unit 22A generates image correspondence information represented by coordinate transform, and performs processing of accumulating the image correspondence information into the storage unit 28 as adjacent coordinate transform information.

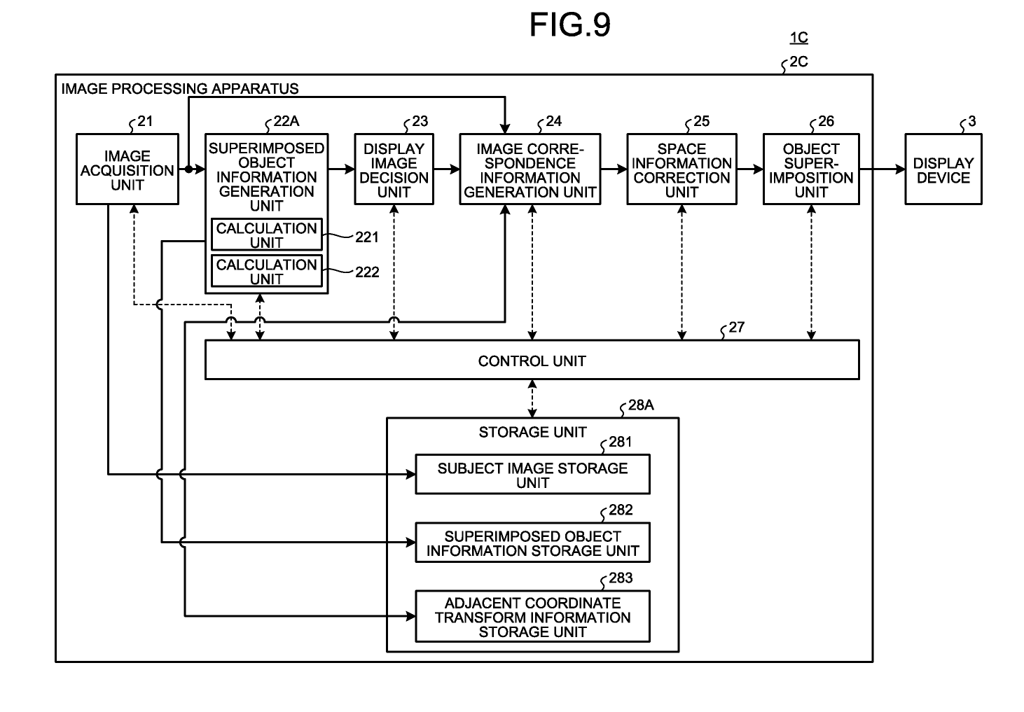

FIG. 9 is a block diagram illustrating a functional configuration of an image processing system according to the third embodiment. An image processing system 1C according to this third embodiment includes an image processing apparatus 2C and the display device 3. In place of the superimposed object information generation unit 22 and the storage unit 28 of the aforementioned image processing apparatus 2, the image processing apparatus 2C includes the superimposed object information generation unit 22A and a storage unit 28A. The superimposed object information generation unit 22A includes a plurality of calculation units (calculation units 221 and 222 in this third embodiment). The storage unit 28A includes the subject image storage unit 281, a superimposed object information storage unit 282, and an adjacent coordinate transform information storage unit 283.

Similarly to the aforementioned superimposed object information generation unit 22, the superimposed object information generation unit 22A detects locations of interest in a subject image that is based on an image signal input from the image acquisition unit 21, and generates space information of superimposed objects that are objects indicating the detected locations of interest, and are to be superimposed on the locations of interest of the subject image. The superimposed object information generation unit 22A detects, by the plurality of calculation units (calculation units 221 and 222), locations of interest in the subject image sequentially input from the image acquisition unit 21, and generates space information of superimposed objects that are objects indicating the detected locations of interest, and are to be superimposed on the locations of interest of the subject image. The superimposed object information generation unit 22A sequentially accumulates, into the superimposed object information storage unit 282, space information of superimposed objects generated by each of the plurality of calculation units.

The image correspondence information generation unit 24 generates adjacent coordinate transform information (primary image correspondence information) including a transform parameter, for a subject image that is based on an image signal input from the image acquisition unit 21, and a subject image that is stored in the subject image storage unit 281, and is a subject image at a time adjacent to the subject image input from the image acquisition unit 21, and sequentially accumulates the adjacent coordinate transform information into an adjacent coordinate transform information storage unit 283. In addition, the adjacent time includes intermittently-adjacent subject images extracted by performing thinning processing or the like on a plurality of sequentially-acquired subject images, and includes combinations of subject images other than those adjacent at the time at which subject images are actually acquired.

In addition, in the case of generating image correspondence information regarding correspondence between the subject image from which the superimposed object information generation unit 22A has detected superimposed objects, and the subject image decided by the display image decision unit 23, the image correspondence information generation unit 24 generates image correspondence information regarding correspondence between the subject image from which the superimposed object information generation unit 22A has detected superimposed objects, and the subject image decided by the display image decision unit 23, by referring to coordinate information being space information of superimposed objects generated by the superimposed object information generation unit 22A, and one or a plurality of pieces of adjacent coordinate transform information accumulated in the adjacent coordinate transform information storage unit 283, and accumulating the adjacent coordinate transform information.

In this manner, in the aforementioned first and second embodiments, for a plurality of subject images existing between the subject image W₁₁ and the subject image W₁₂, space information of superimposed objects and image correspondence information are not generated. In this third embodiment, if an unused thread occurs, space information of superimposed objects is generated for each of the subject images sequentially input.

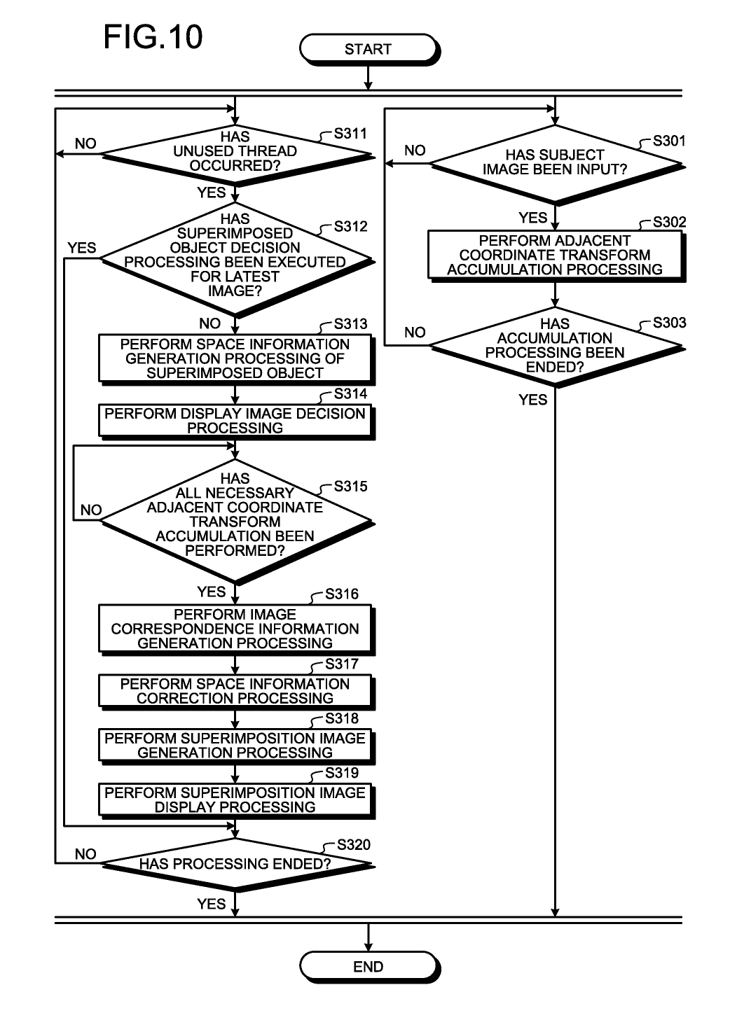

Subsequently, processing performed by each unit of the image processing apparatus 2C will be described with reference to the drawings. FIG. 10 is a flowchart illustrating processing performed by the image processing apparatus 2C according to the third embodiment. The description will be given below assuming that each unit operates under the control of the control unit 27.

First, the control unit 27 determines whether a subject image has been input (Step S301). If the control unit 27 determines that no subject image has been input (Step S301: No), input confirmation of a subject image is repeated. In contrast to this, if the control unit 27 determines that a subject image has been input (Step S301: Yes), the processing shifts to Step S302.

In Step S302, the image correspondence information generation unit 24 generates adjacent coordinate transform information (primary image correspondence information) represented by coordinate transform, for a subject image that is based on an image signal input from the image acquisition unit 21, and a subject image that is stored in the subject image storage unit 281, and is a subject image at a time adjacent to the subject image input from the image acquisition unit 21, and sequentially accumulates the adjacent coordinate transform information into the adjacent coordinate transform information storage unit 283.

After that, the control unit 27 determines whether an accumulation processing end instruction of adjacent coordinate transform information has been input (Step S303). If the control unit 27 determines that an accumulation processing end instruction has not been input (Step S303: No), the processing returns to Step S301, and the aforementioned processing is repeated. In contrast to this, if the control unit 27 determines that an accumulation processing end instruction has been input (Step S303: Yes), the accumulation processing ends. In addition, the input of an accumulation processing end instruction of adjacent coordinate transform information may be an input of a signal input via an input device (not illustrated), or it may be determined that an accumulation processing end instruction has been input, if a new subject image is not input even if a predetermined time elapses from when the last subject image has been input.

Concurrently with the aforementioned accumulation processing, the control unit 27 performs superimposition processing of superimposed objects. First, the control unit 27 determines whether an unused thread has occurred (Step S311). The control unit 27 determines whether an unused thread has occurred, by checking a free space of the CPU, for example. Here, if the control unit 27 determines that an unused thread has not occurred (Step S311: No), confirmation as to whether an unused thread has occurred is repeated. On the other hand, if the control unit 27 determines that an unused thread has occurred (Step S311: Yes), the processing shifts to Step S312. In addition, at this time, the superimposed object information generation unit 22A detects, by any calculation unit of the plurality of calculation units (calculation units 221 and 222), locations of interest in the subject image input from the image acquisition unit 21, and generates space information of superimposed objects that are objects indicating the detected locations of interest, and are to be superimposed on the locations of interest of the subject image. The superimposed object information generation unit 22A selects a calculation unit not performing calculation, and causes the calculation unit to generate space information of superimposed objects, and accumulates the generated space information of superimposed objects, into the superimposed object information storage unit 282.

In Step S312, the control unit 27 determines whether a latest image being a subject image acquired by the image acquisition unit 21 is a subject image for which a superimposed object has been decided. Here, if the control unit 27 determines that the latest image is a subject image for which a superimposed object has been decided (Step S312: Yes), the processing shifts to Step S320. In contrast to this, if the control unit 27 determines that the latest image is not a subject image for which a superimposed object has been decided (Step S312: No), the processing shifts to Step S313. In addition, a state in which a superimposed object has been decided that is said in this step includes a state in which superimposed object decision processing has been executed, or is being executed, and if the control unit 27 determines that the superimposed object decision processing has been executed, or is being executed, the processing shifts to Step S320.

In Step S313, the superimposed object information generation unit 22A generates, from the detection target subject image, space information of superimposed objects to be superimposed on the subject image input from the image acquisition unit 21, or acquires space information of superimposed objects that is stored in the superimposed object information storage unit 282. If there is an unprocessed subject image in the superimposed object information storage unit 282, the superimposed object information generation unit 22A prioritizes superimposed objects of the subject image, and outputs the generated or acquired space information to the display image decision unit 23.

After that, the display image decision unit 23 decides a subject image set according to a time at which the superimposed object information generation unit 22A has completed the generation of space information, or a time at which superimposed objects have been acquired from the superimposed object information storage unit 282, as a subject image to be displayed on the display device 3 (Step S314).

In Step S315 following Step S314, the image correspondence information generation unit 24 acquires space information of superimposed objects that has been generated by the superimposed object information generation unit 22A, and one or a plurality of pieces of adjacent coordinate transform information accumulated in the adjacent coordinate transform information storage unit 283, and sequentially accumulates adjacent coordinate transform information. The image correspondence information generation unit 24 determines, each time accumulation is performed, whether all necessary adjacent coordinate transform information accumulation processing has ended, and if the image correspondence information generation unit 24 determines that all necessary adjacent coordinate transform information accumulation processing has not ended (Step S315: No), the image correspondence information generation unit 24 refers to the adjacent coordinate transform information storage unit 283 and acquires adjacent coordinate transform information. In contrast to this, if the image correspondence information generation unit 24 determines that all necessary adjacent coordinate transform information accumulation processing has ended (Step S315: Yes), the processing shifts to Step S316.

In Step S316, the image correspondence information generation unit 24 sets information obtained by accumulating adjacent image correspondence information in Step S315, as image correspondence information.

In Step S317 following Step S316, the space information correction unit 25 generates, as space information, space information obtained by transforming each coordinate of space information based on the transform parameter of the image correspondence information generated by the image correspondence information generation unit 24.

In Step S318 following Step S317, the object superimposition unit 26 generates a subject image W_{S1} in which the lesion portions S₁₁ and S₁₂ are partially encompassed by the superimposed objects Q₁₁ and Q₁₂, as illustrated in FIG. 3, for example, by superimposing the superimposed objects corrected by the space information correction unit 25, on the subject image decided by the display image decision unit 23.

In Step S319 following Step S318, under the control of the control unit 27, control of displaying the subject image (image on which superimposed objects are superimposed) generated by the object superimposition unit 26, on the display device 3 is performed. After the control unit 27 has displayed the subject image on the display device 3, the processing shifts to Step S320.

In Step S320, the control unit 27 determines whether a processing end instruction has been input. Here, if the control unit 27 determines that a processing end instruction has not been input (Step S320: No), the processing shifts to Step S311, and the aforementioned processing is repeated. On the other hand, if the control unit 27 determines that a processing end instruction has been input (Step S320: Yes), this processing ends.

According to this third embodiment mentioned above, for subject images sequentially input, the superimposed object information generation unit 22A generates space information of superimposed objects, the image correspondence information generation unit 24 generates image correspondence information and performs processing of accumulating the generated image correspondence information into the storage unit 28A as adjacent coordinate transform information, and the image correspondence information generation unit 24 generates image correspondence information between a detection target subject image and a superimposition target subject image by accumulating adjacent coordinate transform information generated between the detection target subject image and the superimposition target subject image, and corrects space information of superimposed objects. With this configuration, image correspondence information may be generated considering motions in subject images existing between the detection target subject image and the superimposition target subject image, and a positional shift of superimposed objects with respect to positions of locations of interest in the superimposition target subject image may be suppressed further surely.

In addition, the present disclosure is not limited to the aforementioned embodiments and the modified examples in an unchanged state. In a practical phase, the present disclosure may be embodied by modifying components without departing from the scope of the disclosure. In addition, variations may be formed by appropriately combining a plurality of components disclosed in the aforementioned embodiments. For example, several components may be deleted from all the components described in the aforementioned embodiments and the modified examples. Furthermore, the components described in the embodiments and the modified examples may be appropriately combined.

In this manner, the present disclosure may include various embodiments not described here, and design changes and the like may be appropriately performed without departing from the technical idea set forth in the claims.

As described above, the image processing apparatus, the image processing method, and the image processing program according to the present disclosure are useful for suppressing a positional shift with respect to positions of locations of interest in a superimposition target image, even in the case of superimposing objects generated based on locations of interest in a detection target image, on an image that is different from the detection target image.

According to the present disclosure, such an effect that, even in the case of superimposing an object generated based on a location of interest in a detection target image, on an image that is different from the detection target image, a positional shift with respect to a position of a location of interest in a superimposition target image may be suppressed may be caused.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

The image processing apparatus and the like according to the present disclosure may include a processor and a storage (e.g., a memory). The functions of individual units in the processor may be implemented by respective pieces of hardware or may be implemented by an integrated piece of hardware, for example. The processor may include hardware, and the hardware may include at least one of a circuit for processing digital signals and a circuit for processing analog signals, for example. The processor may include one or a plurality of circuit devices (e.g., an IC) or one or a plurality of circuit elements (e.g., a resistor, a capacitor) on a circuit board, for example. The processor may be a CPU (Central Processing Unit), for example, but this should not be construed in a limiting sense, and various types of processors including a GPU (Graphics Processing Unit) and a DSP (Digital Signal Processor) may be used. The processor may be a hardware circuit with an ASIC. The processor may include an amplification circuit, a filter circuit, or the like for processing analog signals. The memory may be a semiconductor memory such as an SRAM and a DRAM; a register; a magnetic storage device such as a hard disk device; and an optical storage device such as an optical disk device. The memory stores computer-readable instructions, for example. When the instructions are executed by the processor, the functions of each unit of the image processing device and the like are implemented. The instructions may be a set of instructions constituting a program or an instruction for causing an operation on the hardware circuit of the processor.

The units in the image processing apparatus and the like and the display device according to the present disclosure may be connected with each other via any types of digital data communication such as a communication network or via communication media. The communication network may include a LAN (Local Area Network), a WAN (Wide Area Network), and computers and networks which form the internet, for example.

What is claimed is:

1. An endoscope image processing apparatus comprising
a processor comprising hardware, the processor being configured to execute:
acquiring a plurality of subject images;
generating space information of a superimposed object that is a superimposed object to be superimposed on the subject image, and is to be arranged so as to correspond to a location of interest detected from a detection target subject image that is different from a superimposition target subject image;
deciding the superimposition target subject image to be displayed on a display unit together with the superimposed object, according to a time at which the space information has generated;
generating entire image correspondence information being information that estimates correspondence between the detection target subject image and the superimposition target subject image, using the entire detection target subject image;
correcting space information of the superimposed object based on the information that estimates correspondence between the detection target subject image and the superimposition target subject image; and
superimposing the corrected superimposed object on the decided superimposition target subject image.

2. The endoscope image processing apparatus according to claim 1, wherein the processor further executes generating space information of the superimposed object, for the plurality of subject images.

3. The endoscope image processing apparatus according to claim 1, further comprising a memory configured to store information regarding the subject image,
wherein, when the processor newly acquires a subject image, the processor generates primary image correspondence information between the subject image acquired this time and a subject image acquired last time,
the memory sequentially stores the generated primary image correspondence information, and
the processor generates the entire image correspondence information between the detection target subject image from which space information of the superimposed object has generated, and the decided superimposition target subject image, by accumulating a plurality of pieces of the primary image correspondence information stored in the memory.

4. The endoscope image processing apparatus according to claim 1,
wherein the processor further generates partial image correspondence information between the detection target subject image and the superimposition target subject image, the partial image correspondence information being based on a region corresponding to an arrangement region of the superimposed object in the detection target subject image,
the processor further executes:
calculating first similarity between a first object region corresponding to the superimposed object in the detection target subject image, and a second object region in the superimposition target subject image that is associated with the first object region using the entire image correspondence information, and second similarity between the first object region and a third object region in the superimposition target subject image that is associated with the first object region using the partial image correspondence information; and
selecting either of the entire image correspondence information and the partial image correspondence information based on the first similarity and the second similarity, and
correcting space information of the superimposed object based on the entire image correspondence information or the partial image correspondence information that has been selected.

5. The endoscope image processing apparatus according to claim 1, wherein the processor corrects space information of the superimposed object based on the entire image correspondence information, and then, further corrects the space information based on a pixel value of the detection target subject image and a pixel value of the superimposition target subject image.

6. The endoscope image processing apparatus according to claim 1, wherein the processor generates, as the entire image correspondence information, information that is represented by at least one coordinate transform of a group consisting of nonrigid transform, nomography transform, affine transform, linear transform, scale transform, rotation transform, and parallel displacement.

7. The endoscope image processing apparatus according to claim 1, wherein the space information is at least one of a group consisting of a representative coordinate, a region mask, and an outline.

8. The endoscope image processing apparatus according to claim 6, wherein image processing is performed on the superimposed object.

9. The endoscope image processing apparatus according to claim 1, wherein the processor generates space information of the superimposed object based on the detection target subject image.

10. The endoscope image processing apparatus according to claim 1, wherein the processor generates space information of the superimposed object based on detection information from a sensor.

11. An endoscope image processing method comprising:
sequentially acquiring a plurality of subject images;
generating space information of a superimposed object that is a superimposed object to be superimposed on the subject image, and is to be arranged so as to correspond to a location of interest detected from a detection target subject image that is different from a superimposition target subject image;
deciding the superimposition target subject image to be displayed on a display unit together with the superimposed object, according to a time at which the space information has been generated;
generating entire image correspondence information being information that estimates correspondence between the detection target subject image and the superimposition target subject image, using the entire detection target subject image;
correcting space information of the superimposed object based on information that estimates correspondence between the detection target subject image and the superimposition target subject image; and
superimposing the corrected superimposed object on the decided superimposition target subject image.

12. A non-transitory computer-readable recording medium on which an executable endoscope image processing program is recorded, the endoscope image processing program instructing a processor to execute:
acquiring a plurality of subject images;
generating space information of a superimposed object that is a superimposed object to be superimposed on the subject image, and is to be arranged so as to correspond to a location of interest detected from a detection target subject image that is different from a superimposition target subject image;
deciding the superimposition target subject image to be displayed on a display unit together with the superimposed object, according to a time at which the space information has been generated;
generating entire image correspondence information being information that estimates correspondence between the detection target subject image and the superimposition target subject image, using the entire detection target subject image;
correcting space information of the superimposed object based on information that estimates correspondence between the detection target subject image and the superimposition target subject image; and
superimposing the corrected superimposed object on the decided superimposition target subject image.
